(19) United States
(12) Patent Application Publication
(10) Pub. No.: US 2014/0337080 A1
(43) Pub. Date: Nov. 13, 2014

(54) Radio Frequency Identification Meeting Initiation

(71) Applicant: Crestron Electronics, Inc., Rockleigh, NJ (US)

(72) Inventor: Daniel Jackson, Valhalla, NY (US)

(73) Assignee: Crestron Electronics, Inc., Rockleigh, NJ (US)

(21) Appl. No.: 14/275,817

(22) Filed: May 12, 2014

Related U.S. Application Data
(60) Provisional application No. 61/821,932, filed on May 10, 2013.

(51) Int. Cl. G06Q 10/10; G06K 7/10

(52) U.S. Cl. CPC G06Q 10/1095; G06K 7/10366
USPC 705/7.19

(57) ABSTRACT

A facility scheduling system comprises an RFID reader, a user interface device, a control processor and one or more preset resources. The RFID reader receives information pertaining to a user and a meeting. The RFID reader communicates this information to the control system which in turn retrieves further information about the user and the meeting from a facility security system, a facility management system, and a calendar system. The user is presented with a personalized user interface on the user interface device allowing him to control one or more preset resources according to preset parameters.

### BACKGROUND OF THE INVENTION

1. Technical Field

The present invention relates to facility resources, and more specifically to scheduling of facility resources.

2. Background Art

In large corporate buildings or similar facilities, there may be hundreds or even thousands of conference rooms of various types. Audiovisual (AV) touch screens are common installations in many conference rooms. Currently, buildings may have a dedicated touchscreen which provides local access to a scheduling server. For example, inside of a conference room, a TPMC-V12 V-Panel Integrated 12″ HD Touch Screen available from Crestron Electronics, Inc. of Rockleigh, NJ may serve as a local client running facility management software such as Fusion RV, also available from Crestron Electronics, Inc.

However, some users perceive AV touchscreens to be complicated to use. One of the main reasons for this perception is the amount of interaction that the user must perform on a touchscreen to start a basic videoconferencing call. To initiate a conference call, in certain prior art systems, the user must either scroll through a lengthy company directory to find the correct user, or type in the dialing address manually.

While some prior art systems reduce the user interaction required, there are downsides associated with these systems. The room interface only has access to the room calendar and not individual user calendars. As such, the room must be booked for the meeting ahead of time. A user cannot just walk into a room unplanned and get the same experience.

Accordingly, there is room for improvement in the art.

### SUMMARY OF THE INVENTION

It is to be understood that both the general and detailed descriptions that follow are exemplary and explanatory only and are not restrictive of the invention.

### DISCLOSURE OF INVENTION

In accordance with my invention, a system for accessing a schedule provides a convenient means for starting a scheduled meeting by allowing access to a user interface for starting the meeting by swiping an RFID tag on an RFID reader.

According to a first aspect, the present invention provides a system for initiating a meeting. The meeting initiation system includes at least one processor, a memory associated with the at least one processor, at least one data storage device being operably associated with the memory and the at least one processor, at least one communication interface being operably associated with the at least one processor and memory, and at least one program of instructions stored in the memory and executable in the processor. The at least one communication interface enables communications between the system and a personal identification reader, the system and a scheduling system, and the system and one or more preset resources. The program of instructions being operable to receive information encoded on a personal identification tag, associate the encoded information with a user and a location, request and receive a user calendar associated with the user and a location calendar associated with the location, determine a current meeting from the user calendar and the location calendar, the current meeting being associated with preset information, and send at least one command to a preset resource according to the preset information.

According to a second aspect, the present invention provides a system for initiating a meeting. The meeting initiation system includes an RFID reader configured for reading RFID badge information and transmitting the RFID badge information to a control processor, a touch panel configured for displaying a graphic user interface and receiving one or more inputs from a user and a control processor. The control processor further includes at least one processor, a memory operably associated with the at least one processor, at least one data storage device operably associated with the memory and the at least one processor, at least one communication interface operably associated with the processor and memory and at least one program of instructions stored in the memory and executable in the processor. The at least one communication interface enables communications between the control processor and a personal identification reader, a scheduling system and one or more preset resources. The program of instructions is operable to receive the RFID badge information, associate the RFID badge information with a location, request and receive a user associated with the RFID badge information, the user being associated with a preset preference, request and receive a user calendar for the user and a location calendar for the location from a scheduling system, determine a current meeting from the user calendar and the location calendar wherein the current meeting is associated with preset information, send a command to a touch panel instructing the touch panel to display a graphic user interface and send at least one command to a preset resource according to the preset information in response to receiving the single user input to initiate the current meeting. The graphic user interface is customized according to the preset preference and configured for receiving a single user input for initiating the current meeting.

According to a third aspect, the present invention provides a method for initiating a meeting. The method includes the steps of reading information encoded on a personal identification tag, associating the encoded information with a user and a location, requesting and receiving a user calendar associated with the user, requesting and receiving a location calendar associated with the location, determining a current meeting from the user calendar and the location calendar, the current meeting being associated with preset information, displaying a graphic user interface, wherein the graphic user interface is configured for receiving a single user input for initiating the current meeting, receiving the single user input for initiating the current meeting and sending at least one command to a preset resource according to the preset information in response to receiving the single user input for initiating the current meeting.

The present invention seeks to overcome or at least ameliorate one or more of several problems, including but not limited to: providing a convenient means for starting a meeting.

### BRIEF DESCRIPTION OF DRAWINGS

The accompanying figures further illustrate the present invention.

The components in the drawings are not necessarily drawn to scale, emphasis instead being placed upon clearly illustrating the principles of the present invention. In the drawings, like reference numerals designate corresponding parts throughout the several views.

### BRIEF DESCRIPTION OF THE SEVERAL VIEWS OF THE DRAWING

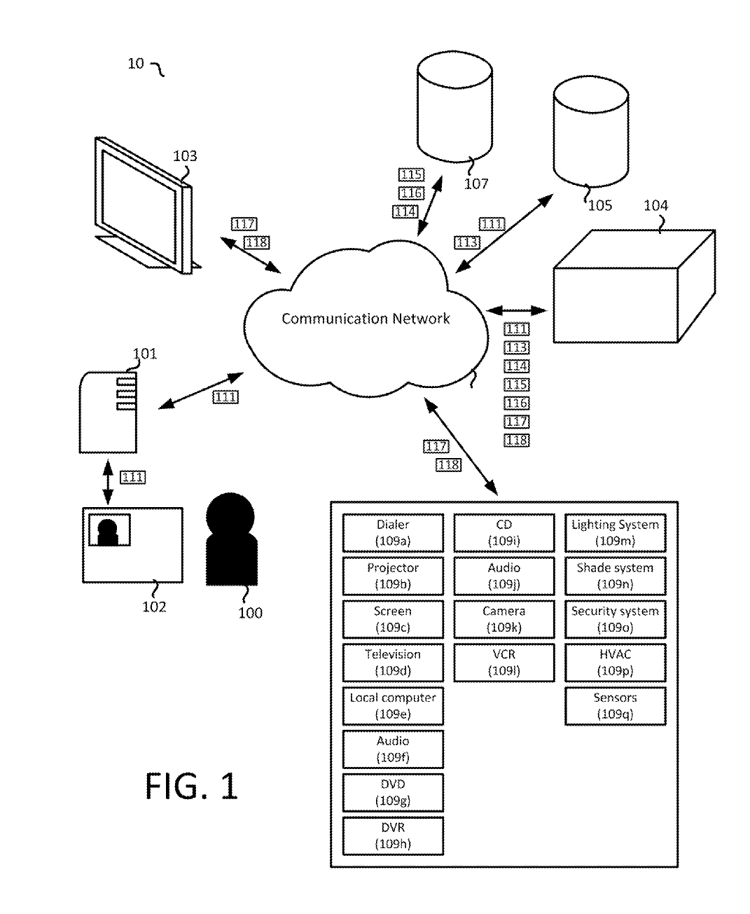

FIG. 1 illustrates a system for initiating a meeting based on preset information, in accordance with an illustrative embodiment of the invention.

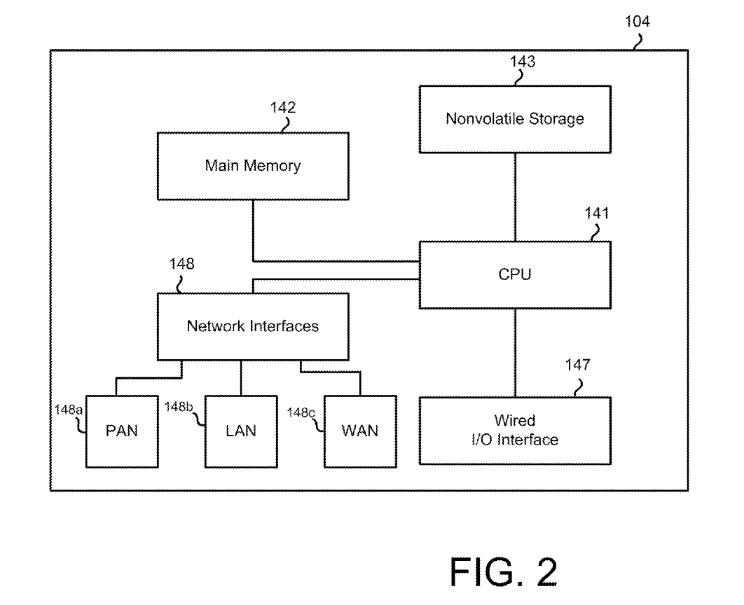

FIG. 2 is a block diagram depicting the control processor for use in the system of FIG. 1, in accordance with an illustrative embodiment of the invention.

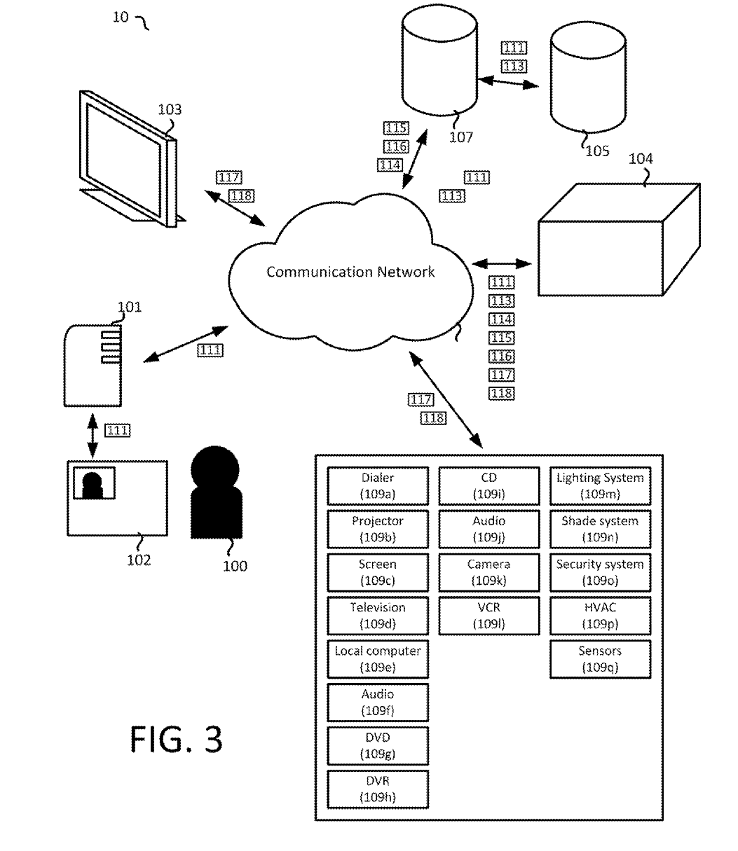

FIG. 3 illustrates a system for initiating a meeting based on preset information, in accordance with an illustrative embodiment of the invention.

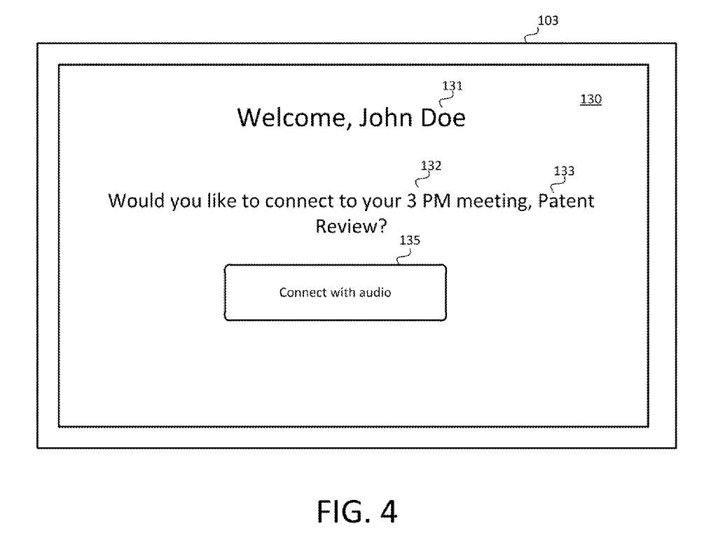

FIG. 4 illustrates a touch panel showing a graphic user interface for initiating a voice call meeting, in accordance with an illustrative embodiment of the invention.

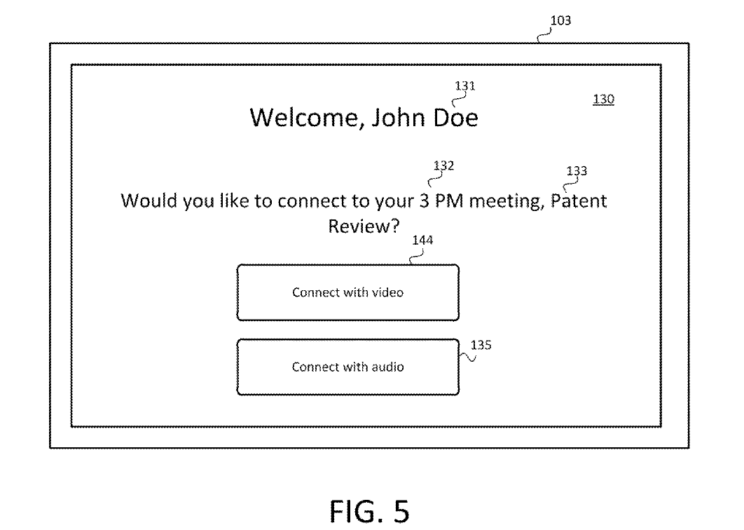

FIG. 5 illustrates a touch panel showing a graphic user interface for initiating a video call meeting, in accordance with an illustrative embodiment of the invention.

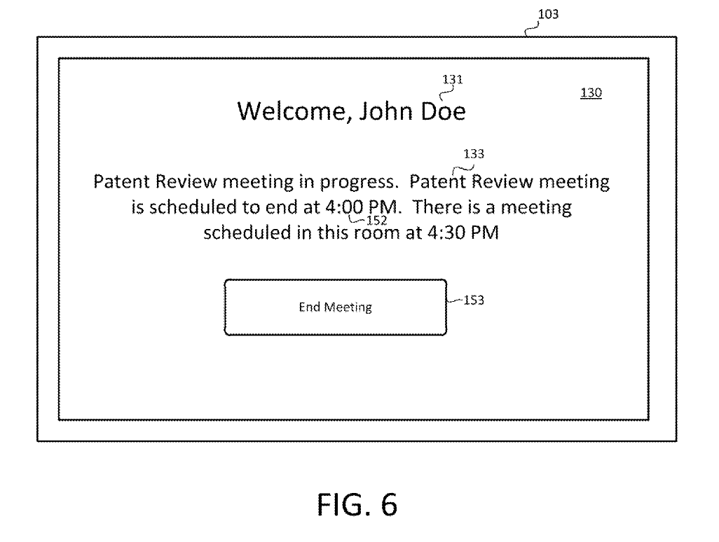

FIG. 6 illustrates a touch panel showing a graphic user interface for ending a meeting, in accordance with an illustrative embodiment of the invention.

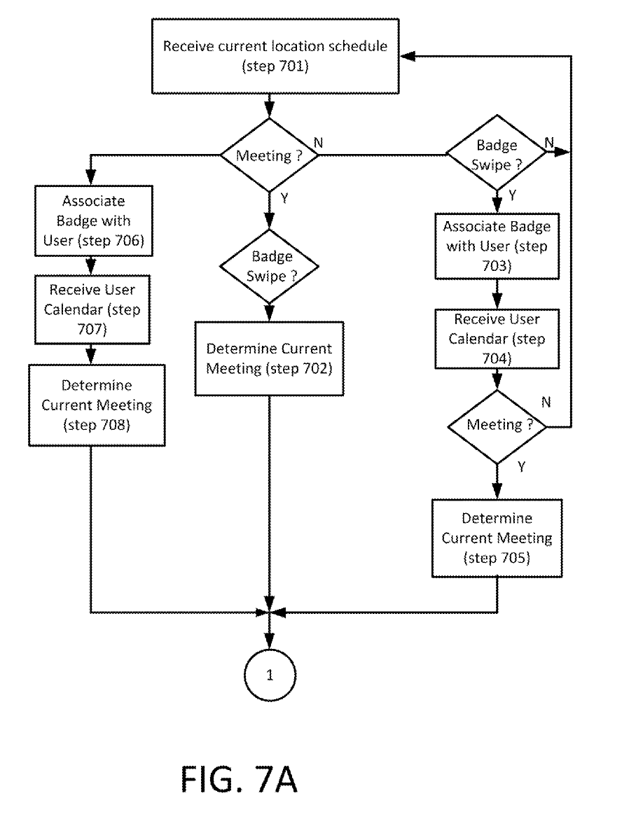

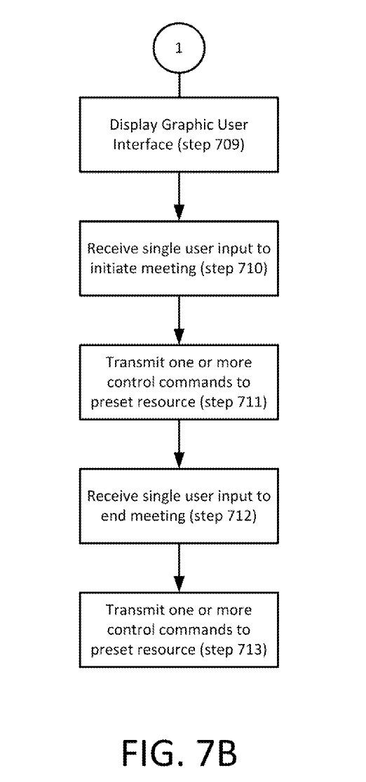

FIG. 7A is a flowchart describing a method for initiating a meeting based on preset information, in accordance with an illustrative embodiment of the invention.

FIG. 7B is a flowchart describing a method for initiating a meeting based on preset information, in accordance with an illustrative embodiment of the invention.

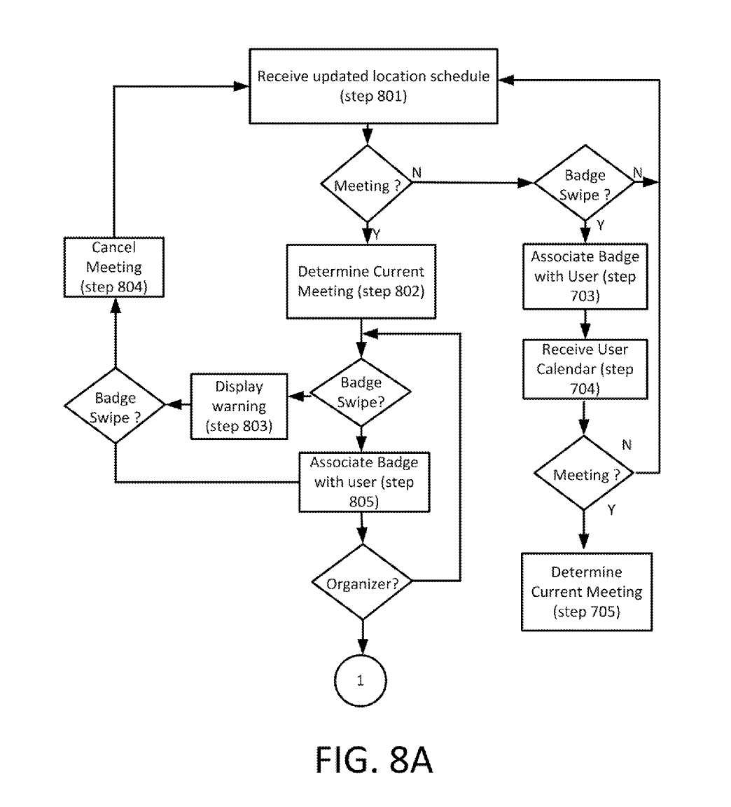

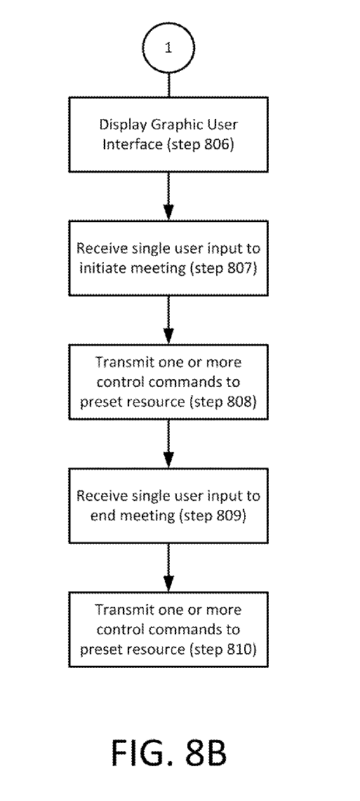

FIG. 8A is a flowchart describing a method for initiating a meeting based on preset information, in accordance with an illustrative embodiment of the invention.

FIG. 8B is a flowchart describing a method for initiating a meeting based on preset information, in accordance with an illustrative embodiment of the invention.

### LIST OF REFERENCE NUMBERS FOR THE MAJOR ELEMENTS IN THE DRAWING

The following is a list of the major elements in the drawings in numerical order.

10 meeting initiation system

100 user

101 personal identification reader

102 personal identification badge

103 touch panel

104 control processor

105 access control system

107 facility management system

109a-m preset resources

111 badge information

113 user information

114 schedule request

115 location calendar

116 user calendar

117 control command

118 feedback

141 CPU

142 main memory

143 nonvolatile storage

147 wired I/O interface

148 network interface

148a PAN interface

148b LAN interface

148c WAN interface

130 graphic user interface

131 organizer

132 start time

133 meeting title

135 initiate audio call icon

144 initiate video call icon

152 end time

153 end meeting icon

701 (step of) receiving current location calendar

702 (step of) determining current meeting

703 (step of) associating badge with user

704 (step of) receiving user calendar

705 (step of) determining current meeting

706 (step of) associating badge with user

707 (step of) receiving user calendar

708 (step of) determining current meeting

709 (step of) displaying graphic user interface

710 (step of) receiving single user interface to initiate meeting

711 (step of) transmitting one or more control commands to a preset resource

712 (step of) receiving single user interface to end meeting

713 (step of) transmitting one or more control command to a preset resource

801 (step of) receiving current location calendar

802 (step of) determining current meeting

803 (step of) displaying warning screen

804 (step of) cancelling current meeting

805 (step of) associating badge with user

806 (step of) displaying graphic user interface

807 (step of) receiving single user interface to initiate meeting

808 (step of) transmitting one or more control commands to a preset resource

809 (step of) receiving single user interface to end meeting

810 (step of) transmitting one or more control command to a preset resource

### DETAILED DESCRIPTION OF THE INVENTION

The present invention is generally implemented as a system for initiating a scheduled meeting at a conference room. The system is suitable for accessing a user calendar and a location calendar at a touch panel and providing a convenient interface for starting a meeting. Hence, an illustrative meeting initiation system and its operation will be described initially.

### MODE(S) FOR CARRYING OUT THE INVENTION

The preferred embodiment of the present invention is described herein in the context of a meeting initiation system for a corporate facility employing radio frequency identification technology, but is not limited thereto, except as may be set forth expressly in the appended claims. The system may be utilized in any facility where a resource is scheduled for use.

FIG. 1 illustrates a system for initiating a meeting, according to one illustrative embodiment of the invention. The system 10 comprises a personal identification reader 101, a user interface device, a control processor 104 and a facility management system 107.

The control processor 104 is configured for communicating with the personal identification reader 101, an access control system 105 and a facility management system 107 to determine a current meeting. The control processor 104 is further configured for instructing a touch panel to display a graphic user interface for initiating the current meeting according to preset information of the current meeting. The graphic user interface is personalized to the user 100 and comprises a selectable region for initiating the meeting with a single user input.

FIG. 2 is a block diagram depicting the control processor 104, according to an illustrative embodiment of the invention. The control processor 104 may be a Pro3 control processor 104 available from Crestron Electronics, Inc of Rockleigh N.J. The control processor 104 is configured for receiving the badge information 111 from the personal identification reader 101. The control processor 104 is additionally used to control various devices, for example, security devices (e.g., door locks), lighting system devices, blinds/drapes, Heating, Ventilating, and Air Conditioning (HVAC) system devices, and sensors such as motion sensors. The control processor 104 may comprise one or more logic engines for processing information such as stored information and information received from external devices and systems such as a personal identification reader 101, an access control system 105, a facility management system 107 and a calendaring system.

The control processor 104 may include at least one central processing unit (CPU). For example, the CPU 141 may represent one or more microprocessors, and the microprocessors may be “general purpose” microprocessors, a combination of general and special purpose microprocessors, or application specific integrated circuits (ASICs). Additionally or alternatively, the CPU 141 may include one or more reduced instruction set (RISC) processors, video processors, or related chip sets. The CPU 141 may provide processing capability to execute an operating system, run various applications, and/or provide processing for one or more of the techniques described herein. Applications that may run on the control processor 104 may include, for example, a logic engine for processing control commands 117 and processing information such as stored information and information received from external devices and systems such as a personal identification reader 101, an access control system 105, a facility management system 107 and a calendaring system.

A main memory 142 may be communicably coupled to the CPU 141, which may store data and executable code. The main memory 142 may represent volatile memory such as RAM, but may also include nonvolatile memory, such as read-only memory (ROM) or Flash memory. In buffering or caching data related to operations of the CPU 141, the main memory 142 may store data associated with applications running on the control processor 104.

The control processor 104 may also include nonvolatile storage 143. The nonvolatile storage 143 may represent any suitable nonvolatile storage medium, such as a hard disk drive or nonvolatile memory, such as Flash memory. Being well-suited to long-term storage, the nonvolatile storage 143 may store data files such as media (e.g., music and video files), software (e.g., for implementing functions on the control processor), preference information (e.g., media playback preferences), wireless connection information (e.g., information that may enable media device to establish a wireless connection such as a network connection).

One or more network interfaces 148 may provide connectivity for the control processor 104. The network interface 148 may represent, for example, one or more NICs or a network controller. In certain embodiments, the network interface 148 may include a PAN interface 148a. The PAN interface 148a may provide capabilities to network with, for example, a Bluetooth® network, an IEEE 802.15.4 (e.g. Zigbee network), or an ultra wideband network. As should be appreciated, the networks accessed by the PAN interface 148a may, but do not necessarily, represent low power, low bandwidth, or close range wireless connections. The PAN interface 148a may permit one electronic device to connect to another local electronic device via an ad-hoc or peer-to-peer connection. However, the connection may be disrupted if the separation between the two electronic devices exceeds the range of the PAN interface 148a.

The network interface 148 may also include a LAN interface 148b. The

LAN interface 148b may represent an interface to a wired Ethernet-based network but may also represent an interface to a wireless LAN, such as an 802.11x wireless network. The range of the LAN interface 148b may generally exceed the range available via the PAN interface 148a. Additionally, in many cases, a connection between two electronic devices via the LAN interface 148b may involve communication through a network router or other intermediary device.

Ethernet connectivity enables integration with IP-controllable devices (i.e. preset resources) and allows the control processor 104 to be part of a larger managed control network. Whether residing on a sensitive corporate LAN, a home network, or accessing the Internet through a cable modem, the control processor 104 may provide secure, reliable interconnectivity with IP-enabled devices, such as touch screens, computers, mobile devices, video displays, Blu-ray Disc® players, media servers, security systems, lighting, HVAC, and other equipment—both locally and globally.

The control processor 104 may also include one or more wired input/output (I/O) interface 147 for a wired connection between one electronic device and another electronic device. One or more wired interfaces may represent a serial port, for example a COM port or a USB port. Additionally, the wired I/O interface may represent, for example, a Cresnet port. Cresnet provides a network wiring solution for Crestron keypads, lighting controls, thermostats, and other devices that don't require the higher speed of Ethernet. The Cresnet bus offers wiring and configuration, carrying bidirectional communication and 24VDC power to each device over a simple 4-conductor cable.

One or more IR interfaces may enable the control processor 104 to receive and/or transmit signals with infrared light. The IR interface may comply with an infrared IrDA specification for data transmission. Alternatively, the IR interface may function exclusively to receive control signals or to output control signals. The IR interface may provide a direct connection with one or more devices such as a centralized AV sources, video displays, and other devices.

One or more programmable relay ports may enable the control processor 104 to control window shades, projection screens, lifts, power controllers, and other contact-closure actuated equipment. One or more “Versiport” I/O ports may enable the integration of occupancy sensors, power sensors, door switches, or anything device that provides a dry contact closure, low-voltage logic, or 0-10 Volt DC signal.

For some embodiments of the control processor 104, the network interfaces 148 may include the capability to connect directly to a WAN via a WAN interface 148c. The WAN interface 148c may permit connection to a cellular data network, such as the EDGE network or other 3G network. When connected via the WAN interface 148c, the control processor 104 may remain connected to the Internet and, in some embodiments, to another electronic device, despite conditions that might otherwise disrupt connectivity via the PAN interface 148a or the LAN interface 148b.

By leveraging remote access of the control processor 104, a user 100 may control the devices or environment settings in a facility from anywhere in the world using a portable electronic device.

The meeting initiation system 10 comprises a communication network which provides access with and between devices of the meeting initiation system 10 as well as between the control processor 104 and external devices. The communication network may be a PAN, LAN, metropolitan area network, WAN, an alternate network configuration or some combination of network types and/or topologies. Communication network may include one or more gateway devices (not shown).

The gateways (not shown) of communication network preferably provide network devices with an entrance to communication network and may include software and/or hardware components to manage traffic entering and exiting communication network and conversion between the communication protocols used by the network devices and communication network. In certain embodiments, the gateways of communication network may function as a proxy server and a firewall server for network devices. Further, the gateways may be associated with a router operable to direct a given packet of data that arrives at a gateway and a switch operable to provide a communication path into and out of each gateway.

In one embodiment, communication network may be a public switched telephone network (PSTN). In alternate embodiments, communication network may include a cable telephony network, an IP (Internet Protocol) telephony network, a wireless network, a hybrid Cable/PSTN network, a hybrid IP/PSTN network, a hybrid wireless/PSTN network or any other suitable communication network or combination of communication networks. In addition, other network embodiments can be deployed with many variations in the number and type of devices, communication networks, the communication protocols, system topologies, and myriad other details without departing from the spirit and scope of the present invention.

The control processor 104 is configured for periodically receiving the location calendar 115 for the location from a facility management system 107 such as a system executing Fusion RV software available from Crestron Electronics, Inc. of Rockleigh, N.J.

Fusion RV is a powerful AV asset management software tool that enables the user to keep track of all rooms in the facility. While connected to each room, Fusion RV displays system and projector power status, lamp life, alerts and other vital statistics as will be further discussed below. This graphic-rich interface empowers AV managers to intelligently manage and support every room. Without Fusion RV, support staffs must roam hallways to check room status, manually view and record projector lamp life, provide in-person help to users, and turn off systems one by one at the end of each day.

Through the Fusion RV interface, a user can schedule rooms—based on its location, capacity, and assets—via the built-in scheduler or via integration with Microsoft® Exchange, IBM Domino®, CollegeNET R25, and Google Calendar. Crestron Fusion RV integrates with Microsoft® Exchange Server for scheduling and with SQL Server® for direct database integration. This enables building occupants to conveniently book rooms based on location, capacity, and assets. Crestron Fusion RV also enables network room scheduling from IBM® Notes®, R25®, Google Calendar™, the RoomView add-in for Outlook®, and from a touch screen conveniently wall-mounted outside each room.

In an embodiment of the invention, the facility management system 107 retrieves the location calendar 115 from a calendar system of the facility. For example, the facility management system 107 may retrieve the user calendar 116 from Microsoft Outlook via integration with Microsoft Exchange Server and SQL Server. In other embodiments of the invention, the facility management system 107 comprises a calendar system for storing the location calendar 115 of the facility.

The location calendar 115 comprises preset information corresponding to preset parameters. Preset parameters may include a date, a start time, an end time, a meeting type, a meeting title, a meeting organizer, a meeting invitee, a phone number, and a video call uniform resource locator. Preset information comprises the values for the preset parameter. For example, 03:00 PM may be the preset information corresponding to the preset parameter of start time.

The control processor 104 is configured for determining a current meeting for the location based on the location calendar 115 and a user calendar 116.

Upon periodically receiving the updated location calendar 115, the control processor 104 is configured for parsing preset information of meetings scheduled for the location to determine a current meeting scheduled for the location. In an embodiment of the invention, a current meeting is a meeting with a date the same as the current date and a start time within a predefined threshold of the current time. For example, the predefined threshold may be a half of an hour.

In another embodiment of the invention, the control processor 104 may determine the next scheduled meeting on the location calendar 115 to be the current meeting regardless of date or start time.

A user 100 may initiate a meeting in their personal user calendar 116 via the personal identification reader 101.

The personal identification reader 101 is configured for reading information encoded on a personal identification device. For example, the personal identification reader 101 may be an RFID reader for reading information encoded on an employee ID badge 102 utilizing RFID communication protocols. Such employee ID badges 102 are commonly used in corporate facilities as an identification means and to enable access to certain locations or resources within the facility.

In this embodiment, the system 10 employs an active reader and a passive employee badge 102. Information is commonly encoded according to ASCII character encoding schemes.

In an embodiment of the invention, the personal identification reader 101 is incorporated into a touch panel providing a convenient means to begin the meeting initiation process as well as initiate the meeting at a single location and at a single device. However, the personal identification reader 101 may also be a stand-alone device or incorporated into a device other than the touch panel.

While the personal identification reader 101 is described as utilizing RFID communication protocols, the personal identification reader 101 is not limited to such protocols. The personal identification reader 101 may utilize any communication protocol, wired or wireless, which may transfer information identifying a user 100 to a personal identification reader 101. For example, in an alternate embodiment of the invention, the personal identification reader 101 may employ Bluetooth technology to receive information identifying the user 100. In another embodiment, the user 100 may simply state his name into a microphone to identify himself to the system 10.

In yet another embodiment, the user 100 may enter badge information 111 or a user ID into the personal identification reader 101, such as through a keypad or other user interface device.

The personal identification reader 101 is further configured for transmitting the encoded badge information 111 to the control processor 104. For example, in an embodiment of the invention, the personal identification reader 101 transmits the ASCII string encoded on the badge 102. The personal identification reader 101 may transmit information via a communication network of the system 10.

The control processor 104 is configured for receiving the encoded badge information 111 from the personal identification reader 101 and associating the information with a user 100 and a location. The control processor 104 may associate the badge information 111 with a location by linking information with the personal identification reader 101. For example, the control processor 104 may store a lookup table associating network addresses of devices and a location.

The control processor 104 associates the badge information 111 with user information 113, such as an email address of the user 100. The user information 113 may be employed by a directory service to locate a user 100 in a database such as a lightweight directory access protocol (LDAP) database or a Microsoft Exchange Server database. These databases are well known in the art and employed in corporate facilities as a directory linking users 100 with email addresses, phone numbers and other information.

In an embodiment of the invention, the control processor 104 communicates with an access control system 105 of a facility to receive the email address of the user 100. Access control systems 105 are typically employed in corporate facilities to serve a security function by restricting access to certain areas by user 100. Generally, in an access control system 105, access to locations or resources is restricted based on an access level set by a security officer of the facility. Employees are identified by security devices such as RFID readers by employee badges which encode a user identification. This user identification is linked with the user in the access control system such as in a lookup table.

The control processor 104 transmits a request to the access control system 105 by providing the badge information 111 received from the personal identification reader 101.

FIG. 3 illustrates a system for initiating a meeting based on preset information, in accordance with an illustrative embodiment of the invention. In an alternative embodiment, the facility management system 107 such as a system executing Fusion RV software communicates with the access control system 105.

In this embodiment, the control processor 104 may transmit the badge information 111 to the facility management system 107. The facility management system 107 may then resolve the user information 113 from the control system to an email address. Advantageously, this embodiment does not require live integration of the control processor 104 with the access control system 105.

Integration of the facility management system 107 with the access control system 105 may be accomplished in a number of different implementations. In one implementation, a lookup table linking badge information 111 with email addresses of users 100 may be stored by the facility management system 107. In this embodiment, the user 100 may be required to duplicate their access control system 105 entries or manually sync with the facility management system 107 via a text or spreadsheet file.

In another implementation, the facility management system 107 supports a one-time enrollment of a user's personal identification badge 102. For example, the first time a user 100 swipes their personal identification tag on the user interface, such as a touch panel, they would be prompted to enter their email address and password.

The facility management system 107 authenticates their login information with a directory service of the facility. In an embodiment of the invention, the facility management system authenticates the login information with Active Directory (AD) to validate that they are an authentic user 100.

Once authenticated, the facility management system 107 would store the badge information 111 with their email address in Fusion and use that to link the badge information 111 and the user 100. The benefit of this implementation is that it does not require any live integration into the access control system 105 or double-entering of information.

In another implementation, the badge information 111 may be stored as an entry in the company directory. Upon receiving the badge information 111 from the control processor 104, the facility management system 107 queries the user's identity by this alias and obtains the user name and email.

In yet another embodiment, a security office of the facility stores the badge information 111 in a profile of the facility management system 107.

The control processor 104 requests a user calendar 116 for the user 100 from the facility management system 107. In embodiments in which the facility management system 107 resolves the user information 113, these requests are accompanied by the badge information 111.

The facility management system 107 in turn retrieves the user calendar 116 and location calendar 115 from a calendar system of the facility. For example, the facility management system 107 may retrieve the user calendar 116 from Microsoft Outlook via integration with the Microsoft® Exchange Server and SQL Server®.

The user calendar 116 comprises preset information as described above in regard to the location calendar 115.

The facility management is further configured to return the user calendar 116 as well as one or more user preference information stored by the facility management system 107. The user preference information may be employed to generate a personalized user interface for the user 100.

Upon determining the current meeting, the control processor 104 controls one or more preset resources 109 in the location according to the preset information and preset user preferences.

The control processor 104 transmits a control command 117 to the user interface device, such as the touch panel 103, to display a graphic user interface 130 for initiating the current meeting. While the user interface is described in this embodiment as a touch panel 103, the user interface is not limited to a touch panel 103. The user interface may be any device suitable for displaying a graphic user interface 130 and receiving one or more user inputs. The user interface may be a dedicated device such as a touch panel 103 or may be a function of a multipurpose device such as a computer, tablet, mobile phone, interactive white board, interactive television display and the like.

FIG. 4 illustrates a touch panel showing a graphic user interface 130 for initiating a voice call meeting, in accordance with an illustrative embodiment of the invention. The graphic user interface 130 comprises a selectable area, such as a graphic icon configured for receiving a single user input to initiate a meeting. For meetings in which the conference type is a voice call, the graphic icon may be a “Start Audio Call” icon. For meetings in which the conference type is a video call, the graphic user interface 130 may comprise a second selectable area, such as a graphic icon configured for receiving a single user input to initiate a video call. For example, the graphic user interface 130 for a video call may comprise a “connect with video” icon and a “connect with audio only” icon.

The graphic user interface 130 may display additional preset information for the meeting such as user name 131, meeting title 133, start time 132 and end time.

Upon receiving the single user input to initiate the meeting, the user interface device transmits feedback 118 to the control processor 104 indicating that the user 100 has input a selection to initiate the meeting. In response, the control processor 104 transmits one or more control commands 117 according to the preset information.

For a voice call, the control processor 104 transmits the phone call dial in number to a phone dialer. Further, the control processor 104 transmits a meeting identification number to the touch panel 103. In an embodiment of the invention, this meeting identification number is also received by the phone dialer and automatically entered after the dial in number is dialed.

In embodiments in which the phone is integrated with a larger audio system, the control processor 104 further transmits one or more control commands to the audio system such as a control command to power up the audio speakers and the audio microphones. The control processor may adjust the volume level according to preset preferences stored by the facility management system and transmitted to the control processor.

FIG. 5 illustrates a touch panel showing a graphic user interface 130 for initiating a video call meeting, in accordance with an illustrative embodiment of the invention. For a video call, the control processor 104 may further parse the meeting information to provide a video conference address to a a video conference system. Depending on the implementation of the video conference system, this may be a meeting URL employed by a Microsoft Lync system or an IP address employed by a Cisco WebEx, Cisco Telepresence Manager System or a Blue Jeans Networks system.

In an embodiment of the invention, the control processor 104 transmits one or more commands to activate a display device. For conference rooms comprising a video display, the one or more commands may comprise a power on device. For conference rooms comprising a projector display, the one or more commands may comprise a lower projector command and a power on command to the projector. The control processor 104 transmits one or more commands to a video recording device such as a webcam or a video conferencing camera.

In embodiments of the invention, the control processor 104 may transmit the one or more command to activate the display device

In an embodiment of the invention, the graphic user interface 130 is generated according to one or more preset preferences transmitting from the facility management system 107 to the control processor 104. The graphic user interface 130 layout, fonts, colors and other design features may be individualized to the user 100.

Additionally, touchscreen layout may be determined according to a level of the employee. For example, users 100 in an enterprise installation may have several different touchscreen layouts that are available depending on the class of user 100. This would also allow a technical user to come into a room, “badge in” and get access to advanced troubleshooting tools.

In an embodiment of the invention, the user 100 may set preferences from the touch screen which are then transmitted to the facility management system 107 for storage.

FIG. 6 illustrates a touch panel showing a graphic user interface 130 for ending a meeting, in accordance with an illustrative embodiment of the invention.

In a further embodiment of the invention, the facility management system 107 may store the username, time and location each time the personal identification reader 101 receives an input. This information may be employed to ascertain trends or other analytic data of the facility.

FIG. 7A and FIG. 7B are flowcharts describing a method for initiating a meeting based on preset information, in accordance with an illustrative embodiment of the invention. The control processor 104 must determine the current meeting from the user calendar 116 and the location calendar 115.

In step 701, the control processor 104 periodically receives the updated location calendar 115 from the facility management system 107. The control processor 104 may receive the updated location calendar 115 at a fixed time interval, in response to a request from the control processor 104 or as a push update from the facility management system 107 in response to an update to the location calendar 115.

The control processor 104 determines whether there are one or more upcoming meetings on the location calendar 115 and if a personal identification badge 102 (i.e. employee ID badge) has been read at the location. The control processor 104 makes this determination based on the preset information of any meetings on the location calendar 115. An upcoming meeting is a meeting which meets one or more predefined criteria such as being within a time range or a date range. For example, in an embodiment of the invention, the predefined criteria is having a date which is the same as the current date.

If there are not one or more meetings on the location calendar 115 and a personal identification badge 102 has not been read, the control processor 104 takes no further action and the control loop returns to step 701.

If there are one or more meetings on the location calendar 115 and a personal identification badge 102 has not been read at the location, in step 702, the control processor 104 determines a current meeting for the location from the one or more upcoming meetings on the location calendar 115. The control processor 104 determines the current meeting by parsing the start time of each upcoming meeting and determining the next meeting.

If there are not one or more meetings on the location calendar 115 and an identification badge 102 has been read at the location, in step 703, the badge information 111 is associated with a user 100.

In an embodiment of the invention, the control processor 104 receives the badge information 111 from a personal identification reader 101. The badge information 111 may comprise an ASCII string. The control processor 104 either directly or via the facility management system 107 resolves the badge information 111 to user information 113 such as a user email address.

In step 704, the control processor 104 receives a user calendar 116 associated with the user 100. The control processor 104 may receive the calendar directly or via the facility management system 107.

The control processor 104 determines whether there are one or more upcoming meetings on the user calendar 116.

If there are not one or more meetings on the user calendar 116, the control processor 104 takes no further action and the control loop returns to step 701.

If there are one or more meetings on the location calendar 115, the control processor 104 determines a current meeting in step 705. The control processor 104 determines the current meeting by parsing the start time of each upcoming meeting and determining the next meeting.

If there are one or more meetings on the location calendar 115 and an identification badge 102 has been read at the location, in step 706, the badge information 111 is associated with a user 100.

In step 707, the control processor 104 receives a user calendar 116 associated with the user 100.

The control processor 104 further determines whether there are one or more upcoming meetings on the user calendar 116.

In step 708, the control processor 104 determines a current meeting of the location. The control processor 104 compares the start time for each of the upcoming meetings and determines the next meeting. However, if the next meeting is a meeting from the user calendar 116 and the end time of the next meeting is after the start time of the next meeting for the location calendar 115, the meeting from the location calendar 115 will be determined to be the current meeting.

In step 709, a graphic user interface 130 is displayed on the touch panel 103. The graphic user interface 130 comprises a selectable area for receiving a single user input for initiating the meeting. In an embodiment of the invention, the graphic user interface 130 comprises a “Connect with Audio” icon. For a voice call, the graphic user interface 130 comprises a “Connect with Video” icon and a “Connect with Audio Only” icon.

Additionally, the graphic user interface 130 displays preset information for the current meeting such as a meeting title, a meeting organizer, a start time and an end time.

In step 710, a single user input to initiate the meeting is received at the control processor 104.

In step 711, one or more control commands 117 are transmitted to one or more preset resources 109. For an audio call, the one or more control commands 117 comprises a command to dial a call in number and a command to enter a meeting identification number. For a video conference, the one or more control commands 117 comprises a command to power a display on, power a video camera on and dial a videoconference url.

In embodiments in which the phone or videoconference system is integrated with a larger audio system, the control processor 104 further transmits one or more control commands to the audio system such as a control command to power up the audio speakers and the audio microphones. The control processor may adjust the volume level according to preset preferences stored by the facility management system and transmitted to the control processor.

The control processor may further transmit control commands to route received video from the video conference system to a local display.

FIG. 8 is a flowchart describing a method for initiating a meeting based on preset information, in accordance with an illustrative embodiment of the invention. In one embodiment of the invention, the personal identification reader 101 further serves a security function for location calendar meetings.

In step 801, the control processor 104 periodically receives the updated location calendar 115 from the facility management system 107. The control processor 104 may receive the updated location calendar 115 at a fixed time interval, in response to a request from the control processor 104 or as a push update from the facility management system 107 in response to an update to the location calendar 115.

The control processor 104 determines whether there are one or more upcoming meetings on the location calendar 115. The control processor 104 makes this determination based on the preset information of any meetings on the location calendar 115. An upcoming meeting is a meeting which meets one or more predefined criteria such as being within a time range or a date range. For example, in an embodiment of the invention, the predefined criteria is having a date which is the same as the current date.

If there are not one or more meetings on the location calendar 115, the control processor 104 takes no further action and the control loop returns to step 801.

In step 802, the control processor 104 determines a current meeting for the location from the one or more upcoming meetings on the location calendar 115. The control processor 104 determines the current meeting by parsing the start time of each upcoming meeting and determining the next meeting.

The control processor 104 determines if a badge 102 has been read at the location within a first predetermined checkpoint in relation to the start date. For example, in an embodiment of the invention, the first predetermined checkpoint is five minutes after the start date.

If a badge 102 hasn't been read within the first predetermined checkpoint, in step 803 a warning notice is displayed on the graphic user interface 130. The warning notice alerts users that the meeting may be cancelled if the organizer does not initiate the meeting within a second predetermined checkpoint. In a further embodiment, the graphic user interface 130 further comprises a timer configured for counting down the time until the end of the second predetermined checkpoint.

The control processor 104 determines if a badge 102 has been read at the location within a second predetermined checkpoint of the start date. For example, in an embodiment of the invention, the second predetermined checkpoint is fifteen minutes after the start date.

If a badge 102 has not been read at the location within the second predetermined checkpoint of the start date, the meeting is cancelled. In an embodiment of the invention, the control processor 104 communicates to the facility management system 107 that the meeting is canceled. The facility management system 107 in turn communicates to the calendaring system to cancel the meeting. Other users 100 would now be free to book the location for a meeting.

If a badge 102 has been read at the location before the first predetermined time checkpoint or the second predetermined time checkpoint, in step 805, the control processor 104 associates the badge information 111 with a user 100.

In an embodiment of the invention, the control processor 104 receives the badge information 111 from a personal identification reader 101. The badge information 111 may comprise an ASCII string. The control processor 104 either directly or via the facility management system 107 resolves the badge information 111 to user information 113 such as a user email address.

The control processor 104 determines if the user 100 is an organizer of the current meeting.

If the user 100 not an organizer of the current meeting, no action is taken and the control processor 104 continues determining if a badge has been read at the location before the first or second predetermined checkpoints.

If the user 100 is an organizer of the current meeting, in step 806, a graphic user interface 130 to initiate the meeting is displayed. The graphic user interface 130 comprises a selectable area for receiving a single user input for initiating the meeting. In an embodiment of the invention, the graphic user interface 130 comprises a “Connect with Audio” icon. For a voice call, the graphic user interface 130 comprises a “Connect with Video” icon and a “Connect with Audio Only” icon.

Additionally, the graphic user interface 130 displays preset information for the current meeting such as a meeting title, a meeting organizer, a start time and an end time.

In step 807, a single user input to initiate the meeting is received at the control processor 104.

In step 808, one or more control commands 117 are transmitted to one or more preset resources 109. For an audio call, the one or more control commands 117 comprises a command to dial a call in number and a command to enter a meeting identification number. For a video conference, the one or more control commands 117 comprises a command to power a display on, power a video camera on and dial a videoconference url.

In step 809, a single user input to end the meeting is received at the control processor 104.

In step 810, one or more control commands 117 are transmitted to one or more preset resources 109.

### INDUSTRIAL APPLICABILITY

To solve the aforementioned problems, the present invention is a unique system in which a user may initiate a scheduled meeting for either the user or the location from a user interface device by swiping a personal identification tag on the user interface.

### LIST OF ACRONYMS USED IN THE DETAILED DESCRIPTION OF THE INVENTION

The following is a list of the acronyms used in the specification in alphabetical order.

AD Active Directory

AV audiovisual

DVD digital video disc

DVR digital video recorder

IP internet protocol

LAN local area network

LDAP lightweight directory access protocol

PAN personal area network

RF radio frequency

RFID radio frequency identification

SQL structured query language

URL uniform resource locator

WAN wide area network

### ALTERNATE EMBODIMENTS

Alternate embodiments may be devised without departing from the spirit or the scope of the invention. For example, the RFID reader may be incorporated into the user interface device.

What is claimed is:

1. A meeting initiation system comprising:
(a) at least one processor;
(b) a memory being operably associated with the at least one processor;
(c) at least one data storage device being operably associated with the memory and the at least one processor;
(d) at least one communication interface being operably associated with the at least one processor and memory, the at least one communication interace configured to enable communications between:
(i) the system and a personal identification reader,
(ii) the system and a scheduling system,
(iii) the system and one or more preset resources; and
(e) at least one program of instructions stored in the memory and executable in the processor, the program of instructions being operable to,
(i) receive information encoded on a personal identification tag,
(ii) associate the encoded information with a user and a location,
(iii) request and receive a user calendar associated with the user and a location calendar associated with the location,
(iv) determine a current meeting from the user calendar and the location calendar, the current meeting being associated with preset information, and
(vi) send at least one command to a preset resource according to the preset information.

2. The meeting initiation system of claim 1 wherein:
(a) the at least one communication interface is configured to enable communication between the system and an access control system; and
(b) the program of instructions is further operable to request and receive the user associated with the encoded information.

3. The meeting initiation system of claim 1 wherein a table associating users with badge information is stored in the memory.

4. The meeting initiation system of claim 1 wherein the at least one command comprises a command to a touch panel instructing the touchpanel to display a graphic user interface and wherein the graphic user interface is configured for receiving a single input for starting the current meeting.

5. The meeting initiation system of claim 4 wherein the program of instructions is further operable to receive one or more preset preferences of the user and wherein the graphic user interface is displayed according to one or more preferences of the user.

6. The meeting initiation system of claim 1 wherein:
(a) the program of instructions is further operable to receive a user input from a touch panel to start the current meeting; and
(b) the at least one command comprises a command to one or more preset resources in response to receiving the user input to start the current meeting.

7. The meeting initiation system of claim 6 wherein the current meeting is a voice call and the at least one command comprises a command to dial a call-in number.

8. The meeting initiation system of claim 6 wherein the current meeting is a video conference and the at least one command comprises at least one command to a video sink device.

9. The meeting initiation system of claim 1 wherein the at least one command comprises a command to a touch panel instructing the touchpanel to display a graphic user interface and wherein the graphic user interface is configured for receiving a single input for ending the current meeting.

10. The meeting initiation system of claim 6 wherein:
(a) the program of instructions is further operable to receive a user input from a touch panel to end the current meeting; and
(b) the at least one command comprises a command to one or more preset resources in response to receiving the user input from the touch panel to end the current meeting.

11. The meeting initiation system of claim 1 wherein
(a) the at least one communication interface is further configured for communicating with a security system; and
(b) the program of instructions is further operable to request from the security system user information associated with the RFID badge information and defining a user and to receive from the security system user information defining a user.

12. A meeting initiation system comprising:
(a) an RFID reader configured for reading RFID badge information and transmitting said RFID badge information to a control processor;
(b) a touchpanel configured for displaying a graphic user interface and receiving one or more inputs from a user; and
(c) a control processor comprising
(i) at least one processor;
(ii) a memory being operably associated with the at least one processor;
(iii) at least one data storage device being operably associated with the memory and the at least one processor;
(iv) at least one communication interface being operably associated with the at least one processor and memory, the at least one communication interface configured to enable communications between the control processor and a personal identification reader, a scheduling system and one or more preset resources; and
(v) at least one program of instructions stored in the memory and executable in the processor, the program of instructions being operable to receive the RFID badge information, associate the RFID badge information with a location, request and receive a user associated with the RFID badge information, the user being associated with a preset preference, request and receive a user calendar for the user and a location calendar for the location from a scheduling system, determine a current meeting from the user calendar and the location calendar wherein the current meeting is associated with preset information, send a command to a touchpanel instructing the touchpanel to display a graphic user interface wherein the graphic user interface is customized according to the preset preference and configured for receiving a single user input for initiating the current meeting, and send at least one command to a preset resource according to the preset information in response to receiving the single user input to initiate the current meeting.

13. The facility scheduling system of claim 12 wherein the control processor is further configured for requesting and receiving a user associated with the RFID badge information from a security system.

14. The facility scheduling system of claim 12 wherein the control processor is further configured for requesting and receiving a user associated with the RFID badge information from a security system.

15. A method for starting a meeting, said method comprising:
(a) reading information encoded on a personal identification tag;
(b) associating the encoded information with a user and a location;
(c) requesting and receiving a user calendar associated with the user;
(d) requesting and receiving a location calendar associated with the location;
(e) determining a current meeting from the user calendar and the location calendar, the current meeting being associated with preset information;
(f) displaying a graphic user interface, wherein the graphic user interface is configured for receiving a single user input for initiating the current meeting;
(g) receiving the single user input for initiating the current meeting; and
(h) sending at least one command to a preset resource according to the preset information in response to receiving the single user input for initiating the current meeting.

16. The method of claim 15 comprising the step of receiving a preset preference associated with the user.

17. The method of claim 16 wherein the step of displaying a graphic user interface further comprises displaying a graphic user interface according to the preset preference.

18. The method of claim 16 wherein the step of sending at least one command to a preset resource according to the preset information further comprises sending at least one command to a preset resource according to the preset information and the preset preference.

19. The method of claim 15 wherein the steps of requesting user calendar information for the user and room calendar information for the location further comprises requesting the user calendar information and location calendar information from a calendaring system.

20. The method of claim 15 wherein the step of sending at least one command to a preset resource according to preset information further comprises dialing a phone number for a conference call.

21. The method of claim 15 wherein the step of sending at least one command to a preset resource according to preset information further comprises powering on a display screen and a video camera.

22. The method of claim 15 further comprising the steps of:
(a) displaying a graphic user interface, wherein the graphic user interface is configured for receiving a single user input for ending the current meeting;
(b) receiving the single user input for ending the current meeting; and
(h) sending at least one command to a preset resource according to the preset information in response to receiving the single user input for ending the current meeting.
